(19) United States
(12) Patent Application Publication
(10) Pub. No.: US 2026/0311184 A1
(43) Pub. Date: Oct. 8, 2026

(54) AGENTIC LARGE LANGUAGE MODELS FOR AUTOMATED MANAGEMENT OF USER AUTHORIZATIONS FOR USE OF EXTERNALLY VAULTED DATA

(71) Applicant: PAYPAL, INC., San Jose, CA (US)

(72) Inventors: Jeffrey Scott Pomeroy, Danville, CA (US); Jonathan Cordeau, Colorado Springs, CO (US); Jon Southall, Kentfield, CA (US)

(21) Appl. No.: 19/638,812

(22) Filed: Apr. 3, 2026

Related U.S. Application Data
(60) Provisional application No. 63/783,579, filed on Apr. 4, 2025.

(51) Int. Cl. G06Q 20/40

(52) U.S. Cl. CPC G06Q 20/4016

(57) ABSTRACT

Provided are methods and systems for automated management of user authorizations for use of externally vaulted data by artificial intelligence agents. A user authorization request is received for an artificial intelligence agent to process a purchase on behalf of a user. An instance of the artificial intelligence agent and a browser usable by the artificial intelligence agent for processing the purchase is initiated. A transaction is created at an online merchant platform using the artificial intelligence agent via the browser within a checkout process. A password manager of a data vault is called to access an encrypted form of a payment credential. The artificial intelligence agent decrypts the encrypted form of the payment credential to obtain the payment credential, populates the payment credential in the checkout process, and processes the transaction using the artificial intelligence agent via the browser.

### CROSS REFERENCE TO RELATED APPLICATION

The present application claims priority to U.S. Prov. Appl. Serial No. 63/783,579, filed Apr. 4, 2025, which is incorporated by reference in its entirety.

### TECHNICAL FIELD

The present disclosure relates generally to agentic large language models (LLMs) and artificial intelligence (AI) agents, and more specifically to utilizing AI agents to handle user requests without user authorization for use of externally vaulted data.

### BACKGROUND

Online service providers may offer various services to end users, merchants, and other entities. These may include providing computing services through different software applications, websites, platforms, and resources, such as those that may be involved with digital transaction processing. Further, the service provider may provide and/or facilitate the use of applications and websites for online payments, peer-to-peer (P2P) transfers, and/or other computing services to different entities including merchants or other entities and their corresponding users (e.g., code developers, employees, agents, etc.). Currently, merchants may provide recommendations to users, and users may search for items from merchants, but there does not exist an intelligent and automated manner in which users may have personalized shopping assistance provided in an autonomous and independently controlled manner. Conventional systems for personalized assistance require active user input, and authorizing purchases and other uses of personal, financial, or otherwise sensitive data requires a user to actively input and authorize use of such data, which is time consuming, prone to input errors and processing delays, and risks data misappropriation when used with fraudulent merchants and other malicious entities.

Even with the increased and expanding uses of artificial intelligence (AI), including helping users with interactions and transactions with different entities and platforms, there continues to be areas that AI systems cannot or are unable to handle, such as various aspects of personalized engagement noted above. Consequently, it is desirable to more fully automate tasks on behalf of users through AI agents that can execute tasks on behalf of users and manage user authorizations for performance of those tasks for improved efficiency and minimal manual efforts spent engaging in unnecessary data browsing and searching tasks.

### BRIEF DESCRIPTION OF THE DRAWINGS

FIG. 1 is a block diagram of a networked system suitable for implementing the processes described herein, according to an embodiment.

FIG. 2 is an exemplary diagram of a sequence of calls and communications between endpoints for automated transaction processing of transactions by an AI agent for purchase authorizations, according to various embodiments.

FIGS. 3A and 3B are exemplary user interfaces of an LLM agent that may be utilizing a browser instance to automatically generate a transaction for a purchase authorization by a user and process the transaction using an externally vaulted payment credential, according to embodiments.

FIG. 4 is a flowchart of an exemplary process performed by agentic LLMs for automated management of user authorizations for use of externally vaulted data, according to an embodiment.

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods and systems for agentic large language models (LLMs) and artificial intelligence (AI) agents for automated management of user authorizations for use of externally vaulted data. Systems suitable for practicing methods of the present disclosure are also provided.

A service provider, such as an online transaction processor, may provide computing services to users and/or their corresponding entities, which may include individual customers or other individuals, merchant customers of an online transaction processor, businesses and their representatives and/or employees, and the like. These computing services may include those associated with electronic transaction processing, peer-to-peer (P2P) payments and transfers, and other computing services involved with payment processing and financial technology services. For these computing services, merchants may provide payment processing options and processing flows on their individual websites and/or native software applications where users may process transactions using their financial instruments including payment credentials for digital accounts, payments cards (e.g., credit/debit cards), bank accounts, and the like. As such, users may visit merchant websites or engage with native software applications where users may browse items for sale (e.g., goods, services, and other products) and may process items for purchase through payment processing and checkout flows that may utilize the transaction processor for payment processing.

Conventionally, users may be required to manually navigate through and browse merchant websites and applications. Currently, merchants may collect “big data” and other information for users, which may be used to provide targeted advertisements and information regarding available items. However, as users, merchants, and service providers move to a more user privacy protected model of data management and use, targeted advertisements have become less favored and are often opted-out of by users or largely ignored. Further, data privacy laws, regulations, and rules may require merchants to comply with certain requirements that may limit their ability to specifically direct users to items of interest. While live agents may assist some users with purchasing items, this is largely infeasible at a large scale due to the number of users interested in items and their numerous requests. Thus, users may still be required to expend significant manually efforts to browse and search for specific items that the users are interested in purchasing.

To address these issues, in various embodiments, a service provider, such as a transaction processor, may provide, or may interface with a third-party AI provider, an autonomous AI service that provides agentic AI services for automated management of user requests and authorizations, which may include authorizations to utilize sensitive, private, and/or financial data stored in a data vault. A service provider may provide a comprehensive, multi-agent generative AI powered system designed for autonomous assistance with transaction processing requests and tasks that may be authorized by a user. This system may be composed of multiple agents, each of which may correspond to an LLM or other type of generative AI model and have specific capabilities. These agents may provide chat interfaces and services, such as natural language conversational capabilities, to engage with users, understand and process user requests in natural language or other prompt/query form, execute tasks and operations with digital merchant platforms including websites and resources for native software applications, and perform electronic transaction processing on behalf of users, which may include access and use of vaulted payment credentials stored in encrypted form in a payment vault. Such AI agents may be authorized to perform payment processing tasks, including retrieval and entry of payment credentials and other sensitive financial information, with merchant websites and with no or minimal user input and/or efforts for manual oversight of payment processing. Consequently, users may save valuable time and service providers may minimize unnecessary data input and processing, which may also reduce network communications and bandwidth issues with unnecessary user browsing and search for merchant items and checkout processes.

To be able to use such services, initially, a user may set up an account and onboard to have their payment credentials or other payment data stored in a credential vault, such as a data vault or other database modeling that may provide long-term data storage for multiple operational systems. This credential vault may be provided by the online transaction processor, which may provide further AI services or may interact with an AI service provider (e.g., OpenAI™ or the like) to instantiate and/or deploy AI agents, such as AI agents utilizing a LLM or other generative AI having conversational capabilities, that may assist users with purchases and purchase processing. With accounts created at the AI service provider and/or payments processed at the AI service provider using input payment and/or financial data from a user, the AI service provider may exchange data with the transaction processor to have payment information vaulted in the credential vault. Although the present disclosure discusses AI agents utilizing an LLM or the like for ease of explanation, it is understood that other types of generative AIs, ML models, and the like may be used in place of, in addition to, and/or to enhance the use of LLMs and corresponding AI agents, as discussed herein.

To do so, the AI service provider may create a public/private key pair for each user and/or account, and share the public key with the transaction processor for use with encrypting data. The private key, usable to decrypt data encrypted using the public key, may be retained by the AI service provider and stored with the user’s account and/or may be provided to the user directly for storage and/or decrypting data. The AI service provider may then, when the user provides or inputs payment data, such as payment card information or credentials, account credentials, and the like, encrypt the input payment data to generate encrypted payment data, which may function as the payment credential for the user and may be passed to the transaction processor for storage. The AI service provider may then call the transaction processor and have the encrypted payment data or other token representing the user’s encrypted payment data and functioning as the user’s payment credential, stored in the credential vault of transaction processor in association with an identifier (ID, such as a customer ID) and/or profile of the user.

The account of the AI service provider may further include a token and/or identifier referencing the encrypted payment data (e.g., payment credential) vaulted at the transaction processor. When the payment credential is retrieved from the transaction processor by the AI service provider, the AI service provider may decrypt payment data from the encrypted payment data corresponding to the payment credential and enter the payment data to a merchant website or application interface for payment processing of a transaction. As such, users may purchase items using user financial instruments that may be encrypted and sent to the transaction processor for vaulting but may also utilize digital accounts with the transaction processor, such as payment accounts. Digital accounts provided by the transaction processor may also act as the payment credential and may be similarly encrypted and stored in the credential vault or may be otherwise tokenized as a payment credential (e.g., a one-time or limited use payment card identifier) that can be provided to a merchant website or application for payment processing. In this regard, tokenization of account data, digital wallet data, or the like may instead be entered by the AI agent in the checkout interface, payment form, and/or processing flow.

A user may establish an account by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like. The user may also be required to provide financial information, including payment card (e.g., credit/debit card) information, bank account information, gift card information, benefits/incentives, and/or financial investments, which may be used to process transactions for items. The user may fund or create the account by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing via agentic AIs discussed herein. The application or website of the service provider, such as PAYPAL® or other online payment provider, may provide payments and the other transaction processing services. As such, payment instruments and credentials vaulted or stored by the transaction processor may include payment cards, financial accounts, and the like for external financial service providers, but may also include and/or correspond to internal digital accounts used to process transactions electronically by the transaction processor.

When requesting automated transaction processing and/or purchases to be made on behalf of a user, a user may engage with an AI agent, which may correspond to a chatbot, chat interface in an application or on a website, or other platform where a user may engage in live chat sessions and dialogue where the user may ask questions, receive responses, issue commands or statements, and/or command or request task processing and completion, such as a request for the AI agent to complete a purchase of one or more items on behalf of the user. AI agents may be provided at the AI service provider and/or hosted and/or deployed in a cloud environment of the AI service provider and/or utilized by the AI service provider and accessible by the user. However, in other embodiments, AI agents may be hosted and/or deployed elsewhere, such as at the transaction processor, in an application on a device of the user, or in another cloud environment, server environment and/or memory space of a service provider, or the like.

The user may command or request that the AI agent process and complete a transaction or purchase on their behalf, such as by transmitting a natural language query, question, statement, or the like to the AI agent via the chat interface and/or in the chat session. The AI agent may utilize a corresponding LLM to process natural language, based on a knowledge base and/or training, and determine the requested item for purchase, the item preferences and/or parameters, a merchant to purchase the item from (and/or merchant website or another online digital platform), and the like. The AI agent may then initiate an instance of a browser in a shared space, such as a sandboxed computing environment in a cloud computing system and/or environment, that may be accessible by the AI agent and the user’s device. The AI agent may then access the merchant’s website, perform browsing, searching, and/or navigating operations and inputs to create a transaction at the merchant website for the item, and automatically enter the item purchase parameters, selections, and the like so that a transaction is ready for checkout. This may include generating a digital shopping cart for the item(s). The transaction may then be processed and completed via a checkout process and/or interface of the merchant website or other platform, such as a checkout processing flow that may be provided by the merchant and/or transaction processor on the website.

During transaction creation, the AI agent may make one or more calls to the transaction processor, for example, to execute risk checks and/or fraud analysis and detection. For example, the transaction processor may provide a risk and fraud detection system, which may utilize one or more AI models, rules, and the like to assess the likelihood or probability of risk and/or fraud of processing the transaction and/or that the user is requesting the transaction and/or authorized to utilize the payment credential for the transaction. The AI agent may also retrieve user preferences for item purchases, preferred merchants, and/or other information and parameters that may be used for creating the transaction.

Once the transaction is created, the AI agent may call a password manager or other application and/or component for the credential vault that may authorize retrieval of the payment credentials and provision to AI agent for use. In this regard, the user may be authorized for access to and/or use of their account with the AI service provider with the AI agent such that the AI agent may have access to the token referencing the user’s payment credential vaulted by the credential vault. The user may be required to further authorize the transaction to be processed, and/or the credentials to be fetched, prior to the AI agent calling the transaction processor to retrieve the payment credential from the credential vault. In some embodiments, the AI agent may also request that the user review and approve the transaction prior to further processing.

Thus, when the AI agent calls the transaction processor for the payment credential, the password manager or other component for the credential vault may authenticate the AI agent, verify the token or other data for retrieval of the payment credential, and retrieve the payment credential, which is then passed to the AI agent. The AI agent may then decrypt the payment data from the payment credential (e.g., the encrypted payment data), and may automatically enter the payment data (e.g., payment card details, bank or other payment account information, billing/shipping information, user information, etc.) to the checkout process for the transaction on the merchant website. The AI agent may then request that the transaction be processed on the merchant website, such as by submitting the transaction for processing with the provided transaction and payment data. In some embodiments, the transaction processor may process the transaction as a backend payment processor, or another payment network and/or processor may complete transaction processing. Thereafter, a receipt and/or other transaction history may be provided to the AI agent, which may then provide the receipt and/or transaction history to the user.

Consequently, using the processes provided herein, agentic AIs may be provided to handle and process user requests and authorizations for purchases more efficiently, quickly, and with less manual oversight and input, with better system resource utilization and allocation, thereby providing faster results and purchase activities in a secure manner. As such, the AI agent system may improve computing services provided through automated computing services and chat interfaces, which may reduce user efforts and manual inputs for individual shopping sessions and purchases. Further, through the use of the separate credential vault, payment information may be stored by systems and storage mechanisms of transaction processors specifically configured for security and regulatory compliance, thereby improving security of AI agents and AI systems when providing automated computing services. Thus, with improved AI services and enhanced integration between processing systems, AI agents and online transaction processors may improve automated AI services offered to users, with enhanced security and reliability.

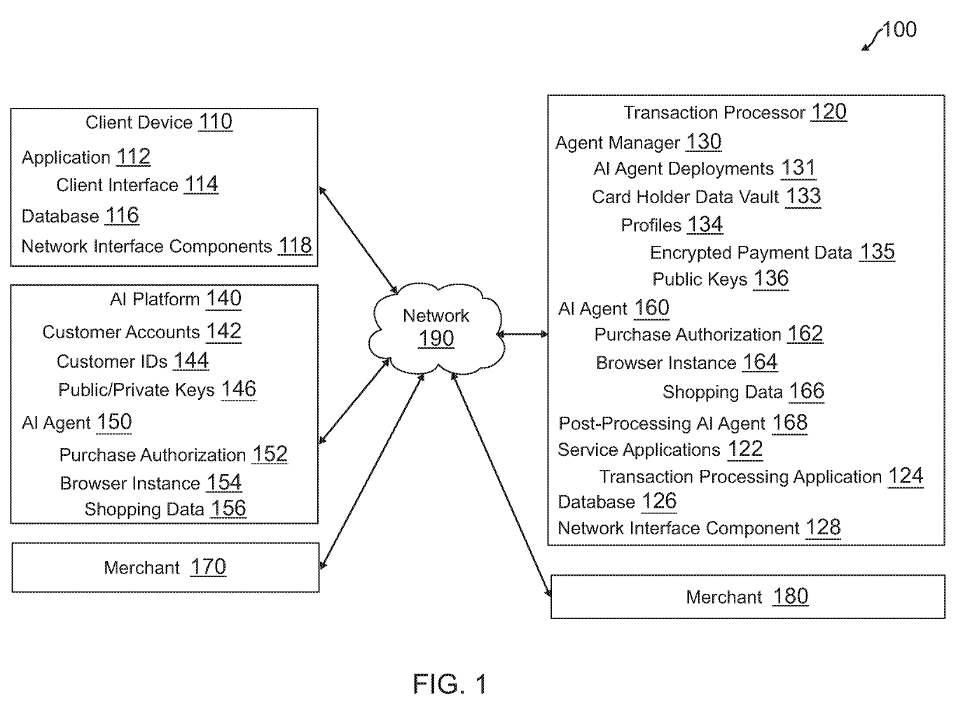

FIG. 1 is a block diagram of a networked system 100 suitable for implementing the processes described herein, according to an embodiment. As shown, system 100 may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIG. 1 may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100 includes a client device 110, a transaction processor 120, an AI platform 140, a merchant 170, and a merchant 180 in communication over a network 190. Client device 110 may be utilized by a customer or other user, including users associated with merchants or other entities, to send and receive communications over network 190 including those associated with purchase requests and other transaction processing requests. Transaction processor 120 may provide various data, operations, and other functions over network 190 to provide services to merchants, users, and their computing systems and devices, including vaulting of payment credentials and other payment data on behalf of users of AI platform 140. In this regard, client device 110 may be used to request automated purchase processing by an AI agent 150 of AI platform 140 or an AI agent 160 of transaction processor 120, which may be deployed by AI platform 140 and/or instantiated based on data provided by AI platform 140. Transaction processor 120 may then be invoked during payment processing to provide a payment credential when AI agent 150 or AI agent 160 arrives at a checkout and/or payment page, process, interface, or the like during a payment processing and/or checkout flow for a transaction generated by AI agent 150 or AI agent 160, as discussed herein. AI agent 150 or AI agent 160 may have generated the transaction for the purchase using a browser instance created by AI agent 150 or AI agent 160, and may process the transaction when the payment credential is received from transaction processor 120.

Client device 110, transaction processor 120, AI platform 140, and websites or other digital platforms of merchants 170 and 180 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 190.

Client device 110 may be implemented as a communication device of a customer or other user that may interact with AI agents 150 and/or 160 for automated purchase processing. Client device 110 may utilize appropriate hardware and software configured for wired and/or wireless communication with transaction processor 120, AI platform 140, AI agents 150/160, and/or merchants 170/180. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1 includes and/or is associated with an application 112, a database 116, and a network interface component 118, implementations of which are discussed further below. Application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user for use with AI agents 150/160, such as to utilize automated purchase processing operations. Application 112 may correspond to specialized software utilized by a user of client device 110 to access and/or utilize a chat interface 114 which may interface with chatbots, chat dialogues and/or sessions, and the like for AI agents 150/160. In some embodiments, chat interface 114 may include a query, a request, a statement, or the like that is provided to receive an answer, assistance, or response based on automated purchase processing operations provided by AI agents 150/160. In some embodiments, chat interface 114 may allow for natural language input, and may receive natural language responses, which may be used for purchase authorizations for AI agents 150/160, as well as receiving results of AI agents 150/160 generating transactions and/or processing those transactions to make purchases of items from users.

In some embodiments, chat interface 114 may further display a browser window or interface for a browser session instanced and/or created by AI agents 150/160 and used to browse a website of merchants 170/180 to locate items, including services, for purchase, create a digital shopping cart and/or transaction, checkout for the transaction, enter payment data and/or details from a fetched payment credential, and/or provide the results of transaction processing. However, in other embodiments, AI agents 150/160 may operate in a “headless browser” implementation where an active browser window and/or interface is not required and instead API calls may be exchanged between websites of merchants 170/180 and AI agents 150/160, as discussed herein. These calls may be exchanged to perform and/or imitate and/or mimic website browsing and/or transaction generation and checkout as if a browser window and interface were open and being used for such browsing.

Application 112 may correspond to a general browser application configured to retrieve, present, and communicate information over the Internet (e.g., utilize resources on the World Wide Web) or a private network. For example, application 112 may provide a web browser, which may send and receive information over network 190, including retrieving website information, presenting the website information to the user, and/or communicating information to the website. However, in other examples, application 112 may include a dedicated application of transaction processor 120 or other entity that may interact with transaction processor 120 during customer service and/or assistance requests. Thus, application 112 may also correspond to different service applications that may provide automated assistance with purchase processing using chatbots and other assistance automations associated with AI agents 150/160. When utilizing application 112 with AI agents 150/160, application 112 may provide chat interface 114 for transmitting prompt, question, or query to AI agents 150/160 and receive responses to such prompt, question, or query.

Client device 110 may further include or have access to database 116, which may correspond to different types of data storage and components including cloud computing storage nodes, remote data stores and database systems, distributed database systems over network 190, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to transaction processor 120.

Client device 110 includes at least one network interface component 118 adapted to communicate with transaction processor 120, AI platform 140, AI agents 150 and 160, websites or other applications and/or platforms of merchants 170 and 180, and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

AI platform 140 may be maintained, for example, by an online service provider that may provide AI services to users including the use of chatbots, conversational AIs, and the like that may be implemented through AI agents for assistance with purchase authorizations and processing. AI platform 140 may be used to deploy, use, communicate with, and/or maintain AI agents 150/160, and may be implemented as a server-system and architecture or in a cloud environment and/or shared space where AI agents 150/160 may be deployed and/or reside. Further, although AI agents 150/160 are shown as residing on or with their respective platform (e.g., AI platform 140 for AI agent 150 and transaction processor 120 for AI agent 160), it is understood that AI platform 140, as well as AI agents 150/160, may be deployed with different service providers (e.g., provided by transaction processor 120 directly) and/or in different computing environments. AI platform 140 of FIG. 1 includes and/or is associated with AI agents 150/160 that may be deployed using LLMs (or other generative AIs), training, and/or knowledge base provided by AI platform 140, implementations of which are discussed further below

AI platform 140 includes customer accounts 142 for different customers and/or users that may utilize AI platform 140 and/or AI agents 150/160 for different AI services including those associated with payment processing based on authorizations provided by users. In this regard, customer IDs 144 may each uniquely identify one of customer accounts 142 and may be utilized as a token for a payment credential stored by a credential vault, such as a card holder data vault 133, however, other tokens may also be utilized. For encryption of sensitive data, public/private keys 146 may be generated, where each account is provided at least one key pair (e.g., a public and private key pair) of public/private keys 146 for asymmetric key encryption. The public keys may be shared with transaction processor 120 for encryption purposes, while the private keys may be retrained by AI platform 140 and usable by AI agents 150/160 and other AI agents or services for decryption.

When AI agents 150/160 or other AI agent, service, or application receives payment data from a user, such as entry of payment card data, a billing address, etc., the payment data may be encrypted and sent to transaction processor 120 for storage in card holder data vault 133. Since transaction processor 120 only has the public key, the encrypted payment data, stored as a payment credential for the user, may be secure and not decryptable by transaction processor 120. However, when AI agents 150/160 engage in purchase processing and have authorization to use the payment credential AI agents 150/160 may use customer IDs 144 or other token to retrieve the corresponding payment credential, decrypt using the private key of public/private keys 146 that the AI agent may have access to from AI platform 140, and enter the data to a checkout process and/or interface for processing.

AI agents 150/160 may correspond to agentic AIs or agentic LLMs with corresponding chatbots that may interact with client device 110 via chat interface 114 to provide conversational AI services using an LLM for prompting/querying and response generation. In this regard, AI agents 150 and 160 are shown deployed with AI platform 140 and transaction processor 120, respectively; however, different deployments may also be provided and/or utilized. AI agents 150/160 may be deployed based on LLMs that are or have been trained and/or configured by AI platform 140 or users of AI platform 140 and/or may be made available via AI platform 140. In this regard, AI platform 140 may provide LLMs and other generative AIs for use with AI agents 150/160. For example, an LLM or other generative AI process that may utilize NNs, ML models, NLP capabilities, and the like trained and configured for purchase processing including transaction generation and payment based on user authorizations for purchases. LLM capabilities may be provided using different language modes, such as an ML module using a generative pre-trained transformer (GPT), Bidirectional Encoder Representations from Transformers (BERT), A Robustly Optimized BERT Pretraining Approach (RoBERTa), or other language model. Although LLMs are discussed in reference to AI agents 150/160, other types of generative AIs, ML models including neural networks (NNs) and deep neural networks (DNNs), and the like may be utilized, which may have corresponding agentic capabilities, as well as natural language processing and/or understanding capabilities.

In some embodiments, LLMs utilized by AI agents 150/160 may include DNNs, MLs, or other AI models trained for language and generative capabilities on a knowledge base. For example, with LLMs, training data may correspond to different corpora of documents and information, which may then allow the models to respond intelligently based on learning for such corpora. The training data may be used to determine features, such as through feature extraction and feature selection using the input training data. With DNN models and/or AI models using deep learning, the models may include one or more trained layers, including an input layer, a hidden layer, and an output layer having one or more nodes; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained with this data and data attributes, as well as corresponding weights, activation functions, and the like using a deep learning algorithm, computation, and/or technique. For example, each of the nodes in the hidden layer generates a representation, which may include a mathematical computation (or algorithm) that produces a value based on the input values of the input nodes. The DNN, ML, or other AI architecture and/or algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node(s) to produce one or more output values for ML models that attempt to classify and/or categorize the input data and provide corresponding language outputs.

Layers, branches, clusters, or the like of the DNNs of may be trained by using training data associated with data records of interest, such as information associated with content, searching, and/or summarization tasks. By providing training data, the nodes in the hidden layer may be trained (adjusted) such that an optimal output (e.g., a classification) is produced in the output layer based on the training data. By continuously providing different sets of training data and/or penalizing the networks when the outputs are incorrect, models (and specifically, the representations of the nodes in the hidden layer) may be trained (adjusted) to improve their performance. Once trained, AI agents 150/160 may be used for processing purchase authorizations 152/162 from users, such as a request and/or command to make a purchase on behalf of the user. Purchase authorizations 152/162 may identify an item, as well as any item parameters, selections, or properties for purchase, as well as select, designate, or authorize a payment credential from card holder data vault 133, or further review and payment credential selection may later be required for transaction approval and processing. AI agents 150/160 may also be trained to initiate and/or instantiate browser instances 154/164 for browsing of merchant websites and other digital platforms, as well as transaction generation. In this regard, browser instances 154/164 may be used to generate shopping data 156/166 for one or more items to purchase in a transaction. Further, shopping data 156/166 may include payment data from a retrieved payment credential, which may be added to the transaction for processing.

Transaction processor 120 may be maintained, for example, by an online service provider, which may provide payment and transaction processing services and operations via one or more digital platforms, applications, websites, and the like. Transaction processor 120 may provide computing services to various entities, which may include computing services provided to AI agents 150 and/or 160 for payment processing include use of payment credentials stored by card holder data vault 133. For example, with the provision of computing products and/or services, AI agents 150 and/or 160 may be invoked to provide automated purchase processing on behalf of users, which may include providing payment credential during transaction processing, processing transactions using those credentials, as well as providing risk and fraud analysis, post-processing services, and/or user preferences and personalization for transaction creation. In one example, transaction processor 120 may be provided by PAYPAL®, Inc. of San Jose, CA, USA. However, in other embodiments, transaction processor 120 may be maintained by or include another type of service provider.

Transaction processor 120 of FIG. 1 includes and/or is associated with service applications 122, a database 126, a network interface component 128, an agent manager 130, and card holder data vault 133, implementations of which are discussed further below. Service applications 122 and agent manager 130 may correspond to executable processes, platforms, applications, and/or associated content and data with corresponding hardware. In other embodiments, transaction processor 120 may include additional or different applications, platforms, and modules having corresponding hardware and/or software as required by their corresponding embodiments.

Agent manager 130 may correspond to one or more applications, processes, and the like, executable by the specialized hardware of transaction processor 120, to provide computing services that may be used to manage different AI agents that may be utilized by users for automated payment processing, such as deployment of AI agents 150 and/or 160, as well as deployment, use, maintenance, and verification of other AI agents that may be deployed in other computing environments, (e.g., cloud-based, server, device-side or in-application, etc.) and/or with other applications, websites, service provider platforms, and the like. In this regard, agent manager 130 may manage AI agent deployments 131, which may correspond to different requests to deploy AI agents 150 and/or 160, as well as other AI agents, to assist users with purchases, transaction creation and merchant browsing/item searching, payment processing, and the like. Agent manager 130 may deploy AI agents on request by users or may maintain a pool of deployed AI agents accessible via chat interfaces and sessions/communications.

AI agent deployments 131 may be provided in a single environment, such as a cloud environment accessible by different websites and/or applications that may utilize and interact with the AI agents, or may be deployed in multiple different environments including cloud environments, server environment, on-device or in-application, and the like, for different capabilities, requirements, and/or accessibility by users and/or devices. AI agent deployments 131 may therefore provide AI agents 150 and/or 160 for access by users, and may manage their deployment, as well as their maintenance and/or recall. Although the processes of agent manager 130 are discussed as occurring with transaction processor 120 and residing in a computing environment of transaction processor 120, it is understood such computing services may be provided and/or occur with AI platform 140 and/or in another computing environment including a cloud environment accessible and/or used by transaction processor 120 and/or AI platform 140.

Card holder data vault 133 may correspond to a data vault where payment credential and other payment data may be securely stored and may correspond to a long-term storage where data from multiple different systems, such as AI platform 140 and/or AI agents 150/160 and other AI agents, may be stored for later retrieval and use during transaction processing. In this regard, card holder data vault 133 may include profiles 134 for different users, which may correspond to accounts with transaction processor 120 and/or customer accounts 142/customer IDs 144 with AI platform 140. In this regard, encrypted payment data 135 may be stored for each of profiles 134, which may correspond to payment credentials that have been encrypted using public keys 136 and may include decryptable payment data that may be entered into a transaction for processing.

Service applications 122 may correspond to one or more applications, processes, and the like, executable by the specialized hardware of transaction processor 120, to provide computing services that may be used to process a transaction and/or provide other digital products and services to users. For example, service applications 122 may include a transaction processing application 124 that may be configured to process payments and provide other payment and transaction processing services to one or more users, merchants, and/or other entities, where use of those services may be utilized by AI agents 150 and/or 160 during automated purchase processing, as discussed herein. In this regard, users, including merchants and other entities, as well as customers and individual users, may establish a digital account for use of transaction processing application 124 and/or other computing services of services applications 122. The account may be used to send and receive payments during payment processing, including those payments that may be enabled and/or authorized to be performed by AI agents 150 and/or 160 using data from card holder data vault 133. A payment account may be accessed and/or used through a browser application and/or dedicated payment application executed by a device, as well as AI agents 150 and/or 160, such as browser instances 154 and/or 164, respectively. Transaction processing application 124 may process payments and may provide transaction histories to client device 110, AI agents 150 and/or 160, and/or another user’s device or account for transaction authorization, approval, or denial of the transaction. Service applications 122 may include other applications for additional financial services that may be associated with account establishment, maintenance, and/or usage, transfers, risk and fraud, lending and/or underwriting, credit, and the like.

Further, service applications 122 may provide different computing services to users and entities through different products and services, including social networking, microblogging, media sharing, messaging, business and consumer platforms, etc. Service applications 122 may provide additional features to transaction processor 120. For example, service applications 122 may include security applications for implementing server-side security features, programmatic client applications for interfacing with appropriate APIs over network 190, or other types of applications. Service applications 122 may contain software programs, executable by a processor, including one or more GUIs and the like, configured to provide an interface to the user when accessing transaction processor 120, where the user or other users may interact with the GUI to view and communicate information more easily. Service applications 122 may include additional connection and/or communication applications, which may be utilized to communicate information to over network 190.

Additionally, transaction processor 120 includes or may access database 126. Database 126 may store various identifiers associated with client device 110 and/or other devices and/or servers that may engage and/or interact with accounts. Database 126 may also store account data, including payment instruments, financial information, account balances, and authentication credentials, as well as transaction processing histories and data for processed transactions. Although database 126 is shown as residing on transaction processor 120 as a database, in other embodiments, other types of data storage and components may be used including cloud computing storage nodes, remote data stores and database systems, distributed database systems over network 190 and/or of a computing system associated with transaction processor 120, and the like.

Transaction processor 120 may include at least one network interface component 128 adapted to communicate with client device 110, AI platform 140, AI agents 150 and 160, websites or other applications and/or platforms of merchants 170 and 180, and/or other devices and servers over network 190. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 190 may be implemented as a single network or a combination of multiple networks. For example, in various embodiments, network 190 may include the Internet or one or more intranets, landline networks, wireless networks, and/or other appropriate types of networks. Thus, network 190 may correspond to small scale communication networks, such as a private or local area network, or a larger scale network, such as a wide area network or the Internet, accessible by the various components of system 100.

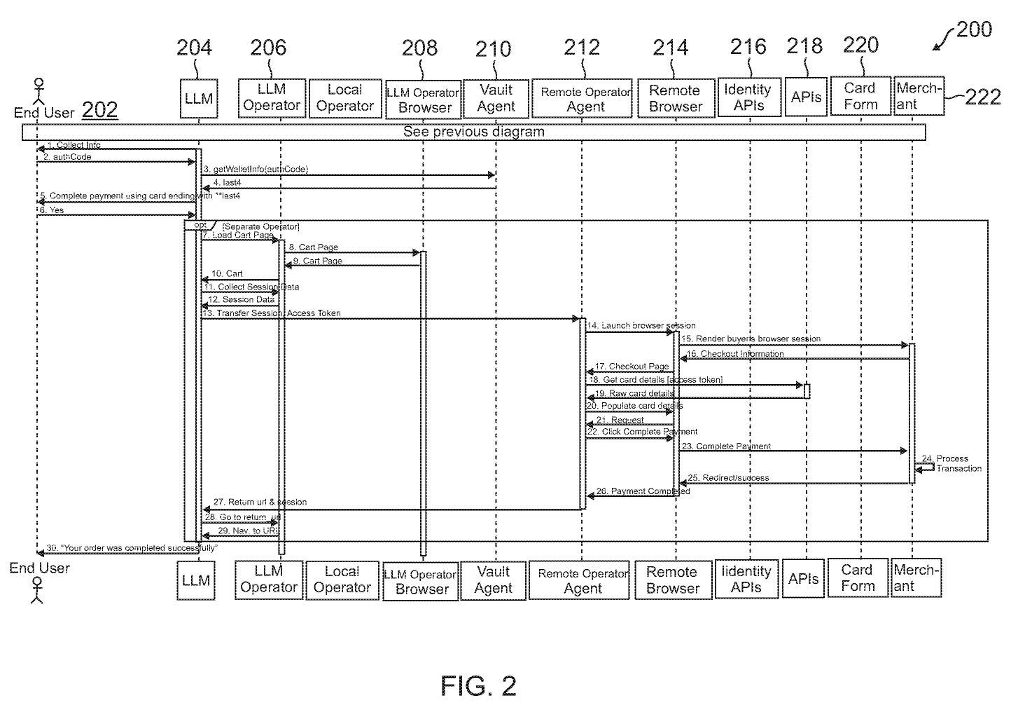

FIG. 2 is an exemplary diagram 200 of a sequence of calls and communications between endpoints for automated transaction processing of transactions by an AI agent for purchase authorizations, according to various embodiments. In this regard, diagram 200 shows a representation of API calls and other communications exchanged between different endpoints and components of a system configured to automatically process and complete transactions for user authorizations of purchases using AI agents. Such AI agents may be configured to automatically provide and process payment data for the purchases by fetching and decrypting a payment credential in a credential vault with a transaction processor. Diagram 200 includes several participants including an end user 202, an LLM 204, an LLM operator 206, an LLM operator browser 208, a vault agent 210, a remote operator agent 212, a remote browser 214, identity APIs 216, APIs 218, a card form 220, and a merchant 222.

In steps 1-6, a sequence of calls, communications, interactions, or other data exchanges begins with initial user interaction and wallet information retrieval. At step 1, information is collected by LLM 204, such as via an AI agent executing or utilizing LLM 204 and/or through an agentic AI interface, for the purchase authorization, which may include an authorization for LLM 204 to process a purchase and payment for a transaction, transaction information including user and/or merchant information, a payment credential or instrument for use, and the like. At step 2, LLM 204 of an AI agent receives an authorization code (e.g., authCode) from end user 202. At step 3, LLM 204 calls a digital wallet information (e.g., a getWalletInfo) function using the authorization code to retrieve wallet information associated with end user 202. At step 4, the last four digits of a card number associated with the wallet are returned to LLM 204. At step 5, LLM 204 queries or requests end user 202 to confirm whether they would like to complete payment using a card ending with the retrieved digits. At step 6, end user 202 provides a confirmation response (e.g., “yes”) indicating agreement to proceed with payment and purchase processing using the stored payment data, and the confirmation is processed such that the AI agent prepares to proceed with the transaction.

In an operator section for an operator separate from the transaction processor and/or merchant checkout service that manages the AI agents, LLMs, and other agentic services, initially, steps 7-13 involve loading and processing cart page information. Although steps 7-29 are shown in a section for the separate operator, steps 7-29 may also or instead be performed by the transaction processor and/or merchant checkout service. At step 7, LLM 204 requests, from LLM operator 206, that a cart page is loaded for the purchase, digital shopping cart, and/or checkout being processed on behalf of end user 202. At step 8, LLM operator 206 initiates a request to load the cart page from a website or other checkout interface of the merchant via LLM operator browser 208, for example, using a browser session and/or instance created or utilized by the AI agent running or utilizing LLM 204. At step 9, the cart page is returned to LLM operator 206 via the instanced browser and website or another checkout interface of the merchant. At step 10, cart information is provided and/or flows to LLM operator browser 208. At step 11, LLM 204 collects the session data from LLM operator 206 that has instanced or created a session of the cart page and browser session. At step 12, the session data is provided from LLM operator 206 to LLM 204 to that the data can be transferred with an access token to remote operator agent 212. At step 13, the session data is prepared for transfer to remote operator agent 212 and the session data along with an access token is transferred to remote operator agent 212. Remote operator agent 212 processes the received session data and access token for subsequent credential retrieval operations.

Steps 14-16 are performed to launch and render the browser session for the buyer. At step 14, remote operator agent 212 initiates a request to launch a browser session with remote browser 214. At step 15, remote browser 214 is instantiated and configured for the transaction from merchant 222 and remote browser 214 renders the browser session with merchant 222, making it accessible for viewing and interaction during the checkout process. At step 16, checkout information for the browser session for the user’s authorized purchase is returned to remote browser 214.

Steps 17-20 handle the retrieval and population of card details for the transaction. At step 17, remote browser 214 then provides the browser session with the checkout page or other checkout interface to remote operator agent 212. At step 18, remote operator agent 212 requests card details using the access token previously provided from APIs 218 of the transaction processor and/or credential vault. The transaction processor and/or credential vault retrieves the encrypted card details based on the request to APIs 218 of the transaction processor and/or credential vault from remote operator agent 212. At step 19, raw card details are returned after decryption. At step 20, the card details are populated in remote browser 214 (e.g., in card form 220 for merchant 222) in the checkout interface, automatically filling in the payment information without requiring manual user input.

Steps 21-26 complete the payment processing with merchant 222. At step 21, a request for payment confirmation may then be returned to remote operator agent 212 from the browser session hosting the checkout interface in remote browser 214. At step 22, a click action to complete payment is initiated by remote operator agent 212 in the browser session of remote browser 214. At step 23, the complete payment request is sent from remote browser 214 to merchant 222. At step 24, merchant 222 receives the payment request with the populated card details and processes the transaction for the purchase authorization from end user 202, for example, through its payment processing systems with the transaction processor or other payment network. At step 25, a redirect or success response is returned in remote browser 214 from merchant 222 indicating the transaction result. At step 26, a payment completed confirmation is generated and passed back through the system from remote browser 214 to remote operator agent 212.

Steps 27-29 handle the return process after payment completion. At step 27, a return URL (e.g., a URL that the user and/or AI agent is returned to after successful transaction processing for the purchase authorization) and session information are provided to facilitate navigation back to the originating context. At step 28, LLM 204 processes the return URL and session information with LLM operator 206 and navigates to the return URL. At step 29, LLM operator 206 navigates to the URL, completing the checkout flow in the browser session, and provides the information back to LLM 204.

At step 30, LLM 204 notifies end user 202 that their order was completed successfully. This notification may be provided via the chat interface and may include order confirmation details, transaction identifiers, and/or other relevant information about the completed purchase. Note that one or more of steps 1-30 may be omitted or combined and/or additional steps may be added as appropriate based on the specific implementation and merchant requirements and that steps may vary as appropriate, e.g., other ways to identify a card number or funding source may be used at step 4 instead of the last four digits of a card.

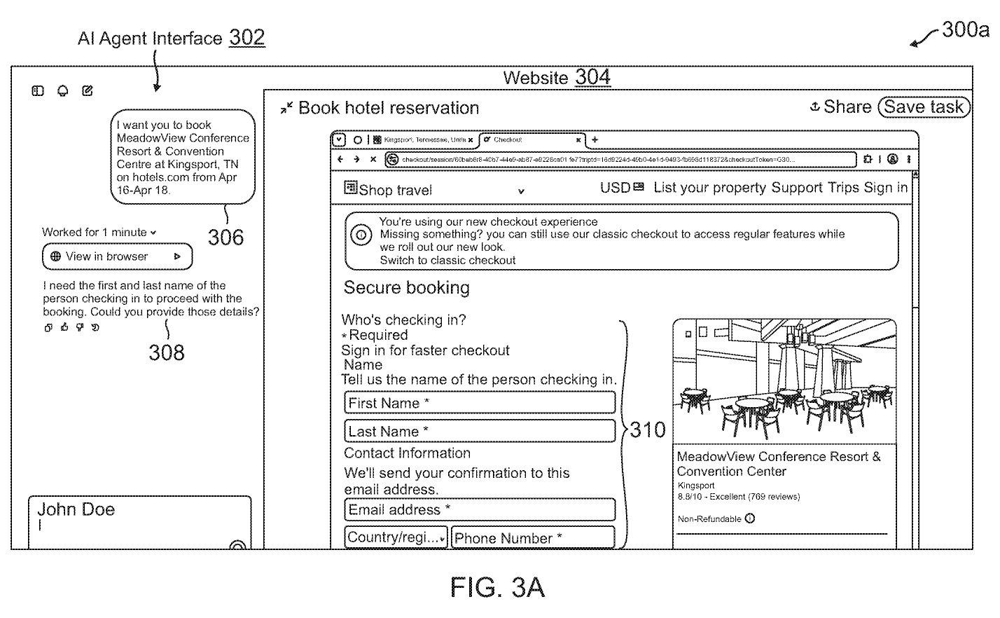

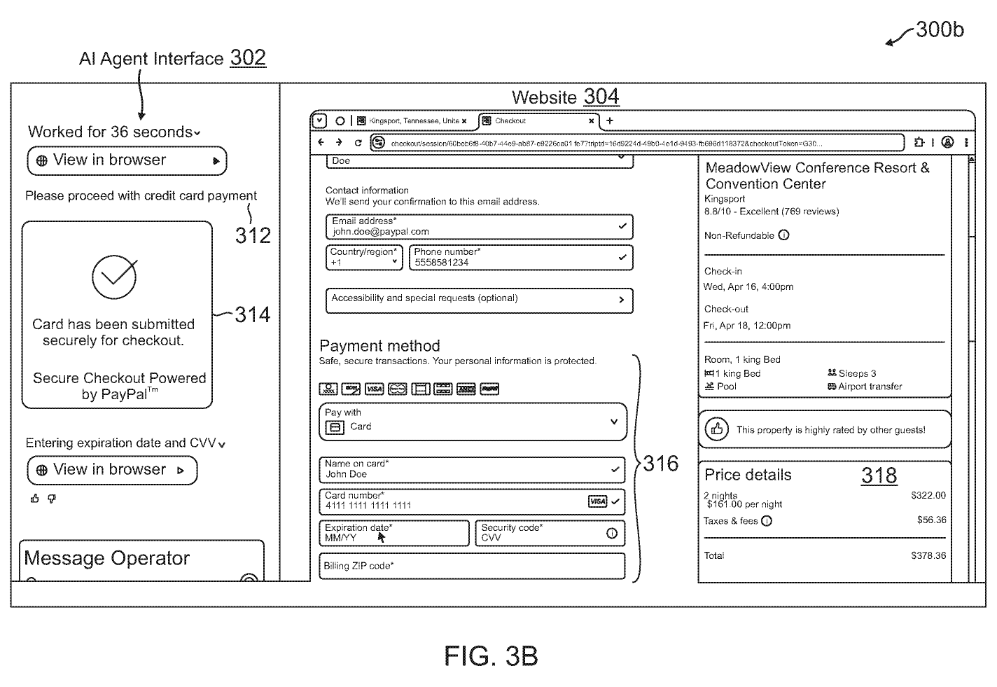

FIGS. 3A and 3B are exemplary user interfaces 300a and 300b of an AI agent that may be utilizing a browser instance to automatically generate a transaction for a purchase authorization by a user and process the transaction using an externally vaulted payment credential, according to embodiments. User interfaces 300a and 300b illustrate different stages of the automated purchase processing workflow, where an AI agent interacts with a merchant website on behalf of a user to complete a transaction. In this regard, user interfaces 300a and 300b may demonstrate how the AI agent may gather necessary information, retrieve payment credentials from an external vault, and populate payment data into checkout forms without requiring manual user input of sensitive payment information.

In FIG. 3A, user interface 300a includes an AI agent interface 302 positioned alongside a website 304 during an automated purchase process, such as a hotel booking. AI agent interface 302 may display a user request 306 at the top, which may contain the user’s instruction or authorization for the AI agent to complete a purchase, such as booking a hotel reservation at a specified location and date range. Below user request 306, an AI agent chat 308 may indicate the status of the AI agent’s work and may display communications between the AI agent and the user. For example, AI agent chat 308 may indicate that the AI agent has been working for a period of time and may request additional information from the user needed to proceed with the booking, such as the name of the person checking in. Website 304 may occupy a portion of user interface 300a and may display a merchant checkout page with a checkout form 310 for completing the transaction. Checkout form 310 may include fields for user information such as first name, last name, email address, country or region, and phone number, along with information about the item being purchased, which may be automatically filled by the AI agent using the agentic services discussed herein. User interface 300a demonstrates a stage in the automated purchase process where the AI agent is gathering information needed to complete the transaction on behalf of the user, which includes completing a checkout page, form, or interface on behalf of the user. Having AI agent interface 302 on the same screen or UI as website 304 enables the user to process and complete a transaction more efficiently, as the user does not need to toggle between the chat and the website or an app to process and complete the transaction.

In FIG. 3B, user interface 300b illustrates a subsequent stage in the automated purchase process where the AI agent has retrieved a payment credential from an external vault and is populating the payment data into the checkout interface. User interface 300b includes AI agent interface 302 positioned alongside website 304. AI agent interface 302 may display status information indicating the AI agent’s progress and may include a purchase authorization 312 section that instructs the user to confirm a purchase authorization and/or confirms the user’s authorization to proceed with payment. Below purchase authorization 312, a card submission confirmation 314 may indicate that the payment card has been submitted securely for checkout via the AI agent (e.g., without user entry and input through the secure agentic vault), which may be performed using a transaction processor as described herein. Such a feature allows the user to remain on the same screen without having separately enter payment details and authorize payment through a different screen. Website 304 may display a checkout page from the merchant website showing details of the item being purchased along with contact information fields that have been populated with user details. A payment method 316 section may be displayed on website 304, showing payment options and fields for card information including name on card, card number, expiration date, security code, and billing information. Payment method 316 section may display payment credential data that has been automatically populated by the AI agent after retrieval and decryption from the credential vault. Price details 318 may be shown on website 304, displaying a cost breakdown including item costs, taxes and fees, and a total amount for the transaction.

As illustrated in user interfaces 300a and 300b, the AI agent may retrieve a payment credential from a transaction processor and/or data vault, decrypt the payment credential, and automatically input the payment data to the website form and/or interface for payment processing and transaction completion. In this manner, the user is not tasked with performing manual input of payment data each time a payment is processed for an authorized purchase with the AI agent or having to switch to a different screen for entry and authorization of payment or funding sources. The automated retrieval and population of payment credentials from an external vault may provide improved efficiency, reduced user effort, and enhanced security by minimizing the exposure of sensitive payment information during the checkout process. Further, by utilizing encrypted payment credentials stored in a credential vault maintained by a transaction processor, the system may ensure that payment data is securely managed and only decrypted by authorized AI agents when needed for transaction processing.

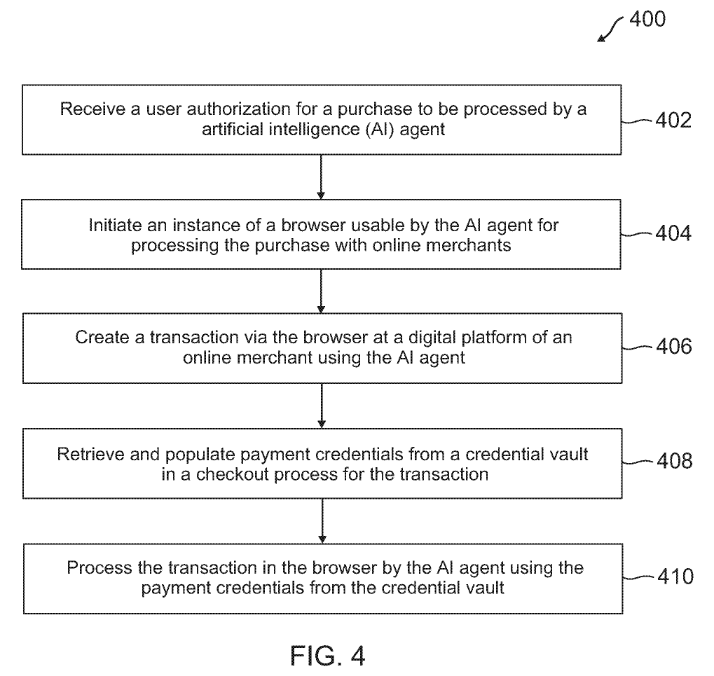

FIG. 4 is a flowchart 400 of an exemplary process performed by agentic AIs for automated management of user authorizations for use of externally vaulted data, according to an embodiment. Note that one or more steps, processes, and methods described herein of flowchart 400 may be omitted, performed in a different sequence, or combined as desired or appropriate.

At step 402 of flowchart 400, a user authorization for a purchase to be processed by an AI agent is received. A user may access an AI agent in a cloud environment, with an AI service provider (e.g., AI platform 140), or with transaction processor 120, which may provide automated purchase processing based on authorizations provided by users. In this regard, one or more AI agents (e.g., AI agents 150 and/or 160) may be deployed by the AI service provider and/or transaction processor 120 and may be utilized by a user via client device 110. In this regard, chat interface 114 in application 112 may provide a conversational platform and interface for the user to utilize the services of AI agents 150 and/or 160. When a user requests that a purchase be processed from AI agents 150 and/or 160, the user may provide an authorization for the corresponding AI agent to identify the items requested for purchase from a merchant and create a transaction. The AI agent may further be authorized to process the transaction and complete a purchase of the item using payment information of the user, which may be vaulted by transaction processor 120.

At step 404, an instance of a browser usable by the AI agent for processing the purchase with online merchants is initiated. After client device 110 engages AI agent 150 or 160 for processing of a purchase authorization, AI agent 150 or 160 may “spin up”, instantiate, open, or create an instance of a browser or other application program that may enable the AI agent to perform web browsing and access to websites of merchants. In other embodiments, other application instances may be created, such as instances of native software applications including marketplace and/or payment processing applications. In this regard, browser instance 154 created by AI agent 150 or browser instance 164 created by AI agent 160 may enable the corresponding AI agent to engage in merchant and item browsing, searching, and navigating for transaction generation. Browser instance 154 and/or browser instance 164 may be created in a sandboxed computing environment in which the AI agent may operate the browser and to which the AI agent and user (via client device 110) may have access to the browser and/or browser results and transaction processing outputs.

At step 406, a transaction is created via the browser at a digital platform of an online merchant using the AI agent. Using browser instance 154 or 164, AI agent 150 or 160, respectively, may navigate to a merchant website and/or search and locate one or more items specified by the user with the purchase authorization for the LLM to purchase the item. This may include the LLM processing text input, determining searches, navigation inputs, and/or other browsing inputs and operations that the LLM may automate on behalf of the user to locate the item(s) and create a transaction for the item(s) for purchase on behalf of the user. In some embodiments, a digital shopping cart may be generated, or the item(s) for purchase may otherwise be added to a checkout process and/or checkout processing flow in one or more checkout interfaces of the merchant website, application, or other digital platform. During transaction generation, transaction processor 120 may be called by AI agent 150 or 160 to perform risk analysis and/or fraud detection checks on the user, merchant, and/or transaction, as well as provide additional information for transaction creation and/or checkout processing.

At step 408, payment credentials are retrieved and populated from a credential vault in a checkout process for the transaction. AI agent 150 or 160 may, when the transaction is ready for processing and/or has been reviewed and approved by the user, call transaction processor 120 to retrieve a payment credential (e.g., encrypted payment data 135 for one of customer IDs 144 for a corresponding account of the user with AI platform 140) for the user. AI agent 150 or 160 may utilize a token for the user’s account with AI platform 140, such as customer IDs 144 or other token representing the payment credential of the user with transaction processor 120. Transaction processor 120 may receive the token and/or request at a processor, such as a password and/or credential manager, and may perform a lookup after authorizing AI agent 150 or 160. One of profiles 134 may be identified for the user and encrypted payment data 135 (e.g., the payment credential) of the user may be retrieved. AI agent 150 or 160 may then receive encrypted payment data 135 and may decrypt the encrypted data using a private key of public/private keys 146 for the user’s account.

At step 410, the transaction is processed in the browser by the AI agent using the payment credentials from the credential vault. Once the payment data for the user has been entered to the transaction, AI agent 150 or 160 may request payment processing of the transaction, which may utilize transaction processor 120 or another payment network and/or processor. In this regard, AI agent 150 or 160 may request the transaction to be processed on the merchant website or in the merchant application and may receive a result of the transaction processing. The user may be updated of the results via AI agent 150 or 160 and/or in browser instance 154 or 164, which may be view via chat interface 114 in application 112 on client device 110.

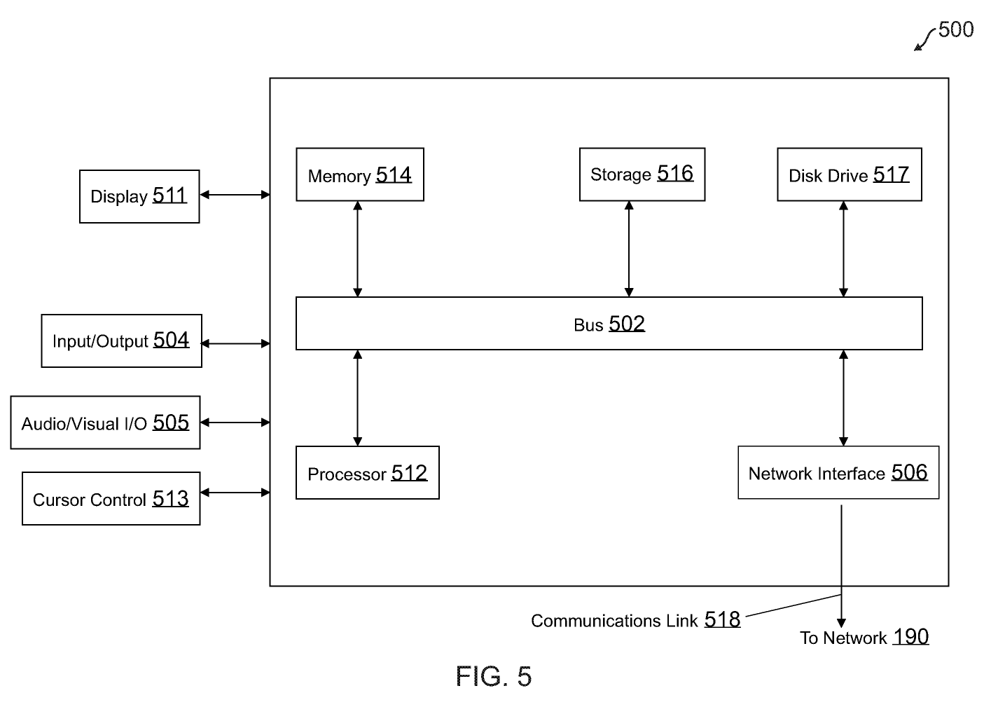

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio/visual input/output component 505 may also be included to allow a user to use voice for inputting information by converting audio signals and/or use video to capture still or video images and provide video input. Audio I/O component 505 may allow the user to hear audio and/or view video. A transceiver or network interface 506 transmits and receives signals between computer system 500 and other devices, such as another communication device, service device, or a service provider server via network 190. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising:
receiving a user authorization request by a user to process a purchase on behalf of the user;
initiating an instance of an artificial intelligence (AI) agent and a browser usable by the AI agent for processing the purchase;
creating a transaction at an online merchant platform of a merchant using the AI agent via the browser, wherein the transaction is created in a checkout process of the online merchant platform;
calling a password manager of a data vault to access an encrypted form of a payment credential from the data vault;
decrypting, by the AI agent, the encrypted form of the payment credential to obtain the payment credential;
populating the payment credential in the checkout process; and
processing the transaction in the checkout process using the AI agent via the brows

2. The method of claim 1, wherein the user authorization request is received via a chat interface configured to receive a natural language input from the user and wherein the payment credential is populated on a same screen as the chat interface.

3. The method of claim 1, wherein initiating the instance of the AI agent comprises deploying the AI agent in a sandboxed computing environment accessible by the AI agent and a client device of the user.

4. The method of claim 1, further comprising:
generating a public key and a private key for an account of the user;
sharing the public key with a transaction processor associated with the data vault; and
retaining the private key for decryption of the encrypted form of the payment credential.

5. The method of claim 4, wherein the AI agent decrypts the encrypted form of the payment credential using the private key.

6. The method of claim 1, further comprising:
prior to creating the transaction, performing a risk analysis or a fraud detection check on at least one of the user, the merchant, or the transaction.

7. The method of claim 1, wherein creating the transaction comprises:
navigating to a website of the merchant via the browser;
locating one or more items specified by the user in the user authorization request; and
adding the one or more items to a digital shopping cart of the checkout process.

8. The method of claim 1, further comprising:
prior to calling the password manager, presenting the transaction to the user for review and approval.

9. The method of claim 1, further comprising:
receiving a result of processing the transaction; and
providing the result to the user via the AI agent.

10. A system comprising:
a non-transitory memory; and
one or more hardware processors coupled to the non-transitory memory and configured to read instructions from the non-transitory memory to cause the system to perform operations comprising:
obtaining a purchase authorization from a user to execute a transaction via an artificial intelligence (AI) agent operating on behalf of the user;
instantiating the AI agent and a browser instance operable by the AI agent for executing the transaction with one or more online merchants;
generating the transaction at a digital platform of a selected merchant of the one or more online merchants utilizing the AI agent through the browser instance, wherein the transaction is generated within a payment processing flow of the digital platform;
invoking a credential manager of a credential vault to retrieve an encrypted version of a payment instrument from the credential vault;
decrypting, by the AI agent, the encrypted version of the payment instrument to obtain funding information of the payment instrument;
entering the funding information into the payment processing flow; and
completing the transaction in the payment processing flow utilizing the AI agent through the browser instance.

11. The system of claim 10, wherein the purchase authorization is obtained via a chat interface configured to receive a natural language input from the user.

12. The system of claim 10, wherein instantiating the AI agent comprises deploying the AI agent in a sandboxed computing environment accessible by the AI agent and a client device of the user.

13. The system of claim 10, wherein the operations further comprise:
generating a public key and a private key for an account of the user;
sharing the public key with a transaction processor associated with the credential vault; and
retaining the private key usable by the AI agent to decrypt the encrypted version of the payment instrument.

14. The system of claim 11, wherein the funding information is entered onto a same screen as the chat interface.

15. The system of claim 10, wherein the operations further comprise:
prior to generating the transaction, performing a risk analysis or a fraud detection check on at least one of the user, the selected merchant, or the transaction.

16. The system of claim 11, wherein generating the transaction comprises:
navigating to a website of the selected merchant via the browser instance;
locating one or more items specified by the user in the purchase authorization; and
adding the one or more items to a digital shopping cart of the payment processing flow on a same screen as the chat interface.

17. The system of claim 10, wherein the operations further comprise:
prior to invoking the credential manager, presenting the transaction to the user for review and approval.

18. The system of claim 11, wherein the operations further comprise:
receiving a result of completing the transaction; and
providing the result to the user via the AI agent on a same screen as the chat interface.

19. A non-transitory machine-readable medium having instructions stored thereon, the instructions executable to cause performance of operations comprising:
receiving an authorization from a user to conduct a purchase via an autonomous agent configured to act on behalf of the user;
launching the autonomous agent and a web browsing session controllable by the autonomous agent for conducting the purchase with online merchants;
creating a purchase transaction at a merchant site of a target merchant from the online merchants using the autonomous agent via the web browsing session, wherein the purchase transaction is created within a checkout flow of the merchant site;
retrieving an encrypted representation of a stored payment method from a secure vault via a credentials application of the secure vault;
decrypting, by the autonomous agent, the encrypted representation of the stored payment method to obtain the stored payment method;
inputting the stored payment method into the checkout flow; and
finalizing the purchase transaction in the checkout flow using the autonomous agent via the web browsing session.

20. The non-transitory machine-readable medium of claim 19, wherein the authorization is received via a chat interface displayed on a screen of a device of the user, wherein the purchase transaction and the stored payment method are displayed on the screen with the chat interface .
